(19) United States
(12) Patent Application Publication
(10) Pub. No.: US 2025/0279465 A1
(43) Pub. Date: Sep. 4, 2025

(54) JIG FOR FIXING

(71) Applicant: SHIN YOUNG MACHINERY CO., LTD., Gyeongju-si (KR)

(72) Inventor: Jun Hyoung LEE, Ulsan Metropolitan City (KR)

(21) Appl. No.: 18/939,483

(22) Filed: Nov. 6, 2024

(30) Foreign Application Priority Data
Mar. 4, 2024 (KR) 10-2024-0030794

(51) Int. Cl. H01M 10/04

(52) U.S. Cl. CPC H01M 10/0481; H01M 2220/20

(57) ABSTRACT

Provided is a fixing jig capable of controlling a surface pressure for pressurizing a battery module assembly when fixing the battery module assembly to an electric vehicle, which includes: a pair of body units facing each other each having one end branched into a supporting portion and a pressurizing portion formed therebetween with an insertion groove into which a part of the electric vehicle is inserted; a pressurizing member rotatably installed inside the pressurizing portion to pressurize the battery module assembly by controlling the surface pressure while selectively and partially protruding outward from the pressurizing portion; and a control unit provided on one side of the body unit to control a rotating degree of the pressurizing member to control a protruding degree of the pressurizing member outward from the pressurizing portion. Thus, a noise or overheating of the battery module assembly is prevented.

### BACKGROUND OF THE INVENTION

### 1. Field of the Invention

The present invention relates to a fixing jig, and more particularly, to a fixing jig configured such that a battery module assembly is fixed by the jig capable of controlling a surface pressure during fixing the battery module assembly to an electric vehicle, thereby preventing a damage to the product's appearance, so that a noise caused by gaps inside the battery module assembly or an overheating of the battery module assembly can be prevented.

### 2. Description of the Related Art

In general, a battery is installed inside a vehicle to provide a power to the vehicle and repeatedly used after recharging the used power by driving the vehicle, and the battery are fixed by a battery holder.

In particular, because a large vehicle such as a large truck uses a large amount of electricity and uses multiple batteries, the battery holder is required to be produced largely and stably.

FIG. 1 is a perspective view showing a structure of a conventional battery holder capable of fixing a battery.

As shown in FIG. 1, a battery holder 1 includes a fixed frame 2, a support piece 3 provided on an upper part of the fixed frame 2 and installed thereon with a battery, vertical pieces 4 provided vertically on both sides of the support piece 3, a side support piece 5 for connecting and fixing both ends of the vertical pieces, and a plurality of fixing bolts 6 and fixing nuts 7 for connecting the above components.

The fixed frame 2 and the support piece 3 are formed with concavo-convex parts throughout the entire surface to provide rigidity when the battery is mounted, and the vertical pieces 4 are formed with a plurality of holes so as to be attached to the vehicle. In addition, the side support piece 5 prevents the mounted battery from being separated from the support piece.

However, according to the above conventional battery holder, a worker manually align numerous bolt holes one by one and then manually assemble the fixing bolts and fixing nuts in order to combine the components, and accordingly, it may take a long time to work and the work efficiency may be lowered, thereby causing the increase in cost.

### SUMMARY OF THE INVENTION

An object of the present invention proposed in consideration of the above conventional problems is to provide a fixing jig configured such that a battery module assembly is fixed by the jig capable of controlling a surface pressure during fixing the battery module assembly to an electric vehicle, thereby preventing a damage to the product's appearance, so that a noise caused by gaps inside the battery module assembly or an overheating of the battery module assembly can be prevented.

The fixing jig for achieve the above-mentioned object of the present invention refers to a fixing jig capable of controlling a surface pressure for pressurizing a battery module assembly when fixing the battery module assembly to an electric vehicle, and includes: a pair of body units facing each other each having one end branched into a supporting portion and a pressurizing portion, in which an insertion groove into which a part of the electric vehicle is inserted is formed between the support member and the pressurizing portion; a pressurizing member rotatably installed inside the pressurizing portion to pressurize the battery module assembly by controlling the surface pressure while selectively and partially protruding outward from the pressurizing portion; and a control unit provided on one side of the body unit to control a rotating degree of the pressurizing member to control a protruding degree of the pressurizing member outward from the pressurizing portion.

The pressurizing portion may have a length relatively longer than a length of the supporting portion.

In addition, the pressurizing member may be rotatably connected to an inside of the pressurizing portion by a fastening bolt, and the control unit may include: a plurality of cylinders each connected to an area opposite to the area fixed to the pressurizing portion and fastened by the fastening bolt so as to rotate the pressurizing member; air hoses connected to one sides of the cylinders to apply an air pressure to the cylinders, respectively; and a toggle switch for selectively turning on and off a supply of air supplied through the air hose.

In addition, the pressurizing member may be formed at a lower side thereof with an inclined surface from a fastening area fastened by the fastening bolt, and when the pressurizing member rotates, the area formed with inclined surface may protrude outward from the pressurizing portion to pressurize the battery module assembly.

In addition, a length of the area formed with the inclined surface based on the fastening area fastened by the fastening bolt in the pressurizing member may be relatively shorter than a length of an area excluding the area formed with the inclined surface.

In addition, the body unit may be installed on a central area of a top surface thereof with a grip member gripped when the fixing jig is carried.

As described above, the fixing jig according to the present invention is configured such that a battery module assembly is fixed by the jig capable of controlling a surface pressure during fixing the battery module assembly to an electric vehicle, thereby preventing a damage to the product's appearance, so that a noise caused by gaps inside the battery module assembly or an overheating of the battery module assembly can be prevented.

### BRIEF DESCRIPTION OF THE DRAWINGS

FIG. 1 is a perspective view showing a structure of a conventional battery holder capable of fixing a battery.

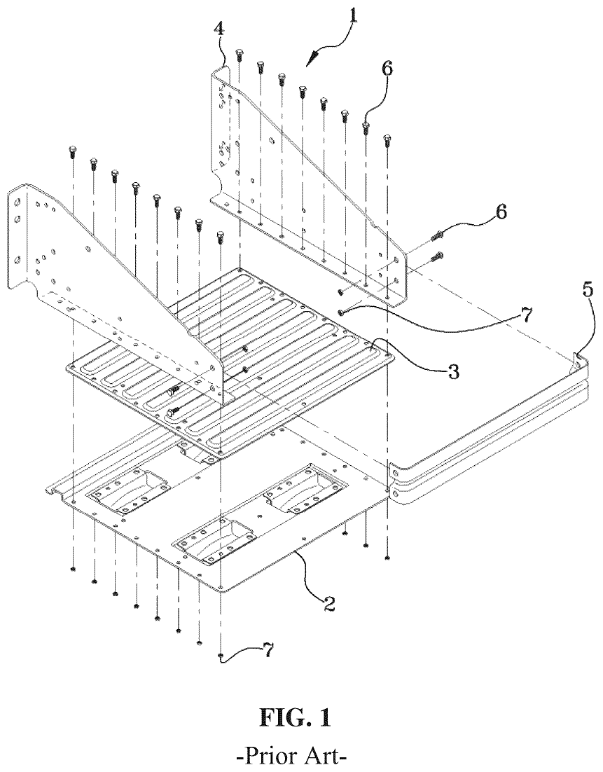

FIG. 2 is a rear view showing a structure of a fixing jig according to one embodiment of the present invention when viewed from a rear.

FIG. 3 is a side view showing the structure of the fixing jig according to one embodiment of the present invention when viewed from a side.

FIG. 4 is a plan view showing the structure of the fixing jig according to one embodiment of the present invention when viewed from a top.

FIG. 5 is an operating view showing the operation of the fixing jig according to one embodiment of the present invention.

### DETAILED DESCRIPTION OF THE INVENTION

Hereinafter, a fixing jig according to one embodiment of the present invention will be described in more detail as follows with reference to the accompanying drawings.

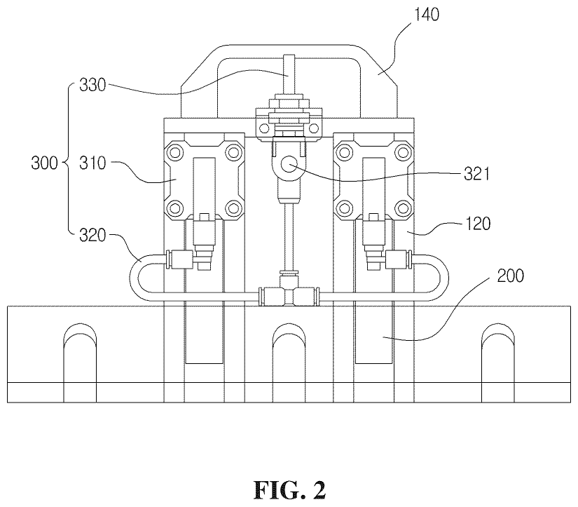

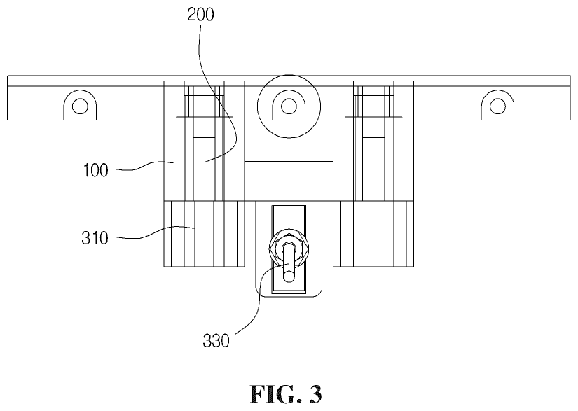

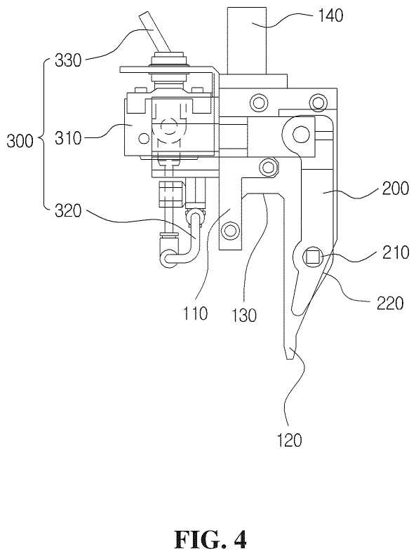

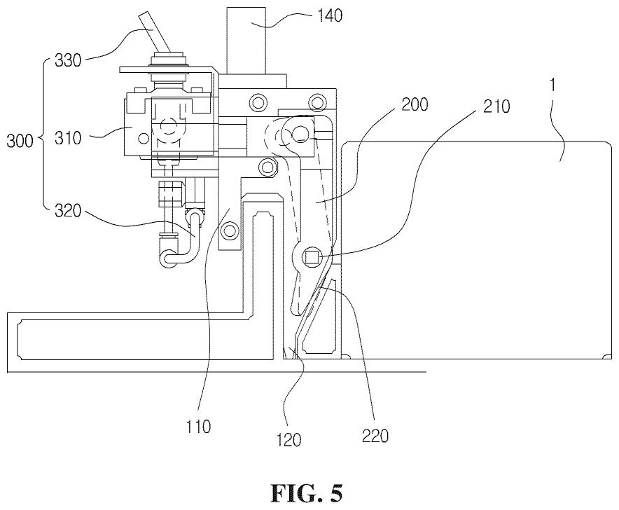

FIG. 2 is a rear view showing a structure of the fixing jig according to one embodiment of the present invention when viewed from a rear. FIG. 3 is a side view showing the structure of the fixing jig according to one embodiment of the present invention when viewed from a side. FIG. 4 is a plan view showing the structure of the fixing jig according to one embodiment of the present invention when viewed from a top. FIG. 5 is an operating view showing the operation of the fixing jig according to one embodiment of the present invention.

As shown in the drawings, the fixing jig according to the present invention refers to a fixing jig for controlling a surface pressure applied to a battery module assembly 1 when fixing the battery module assembly 1 to an electric vehicle, and includes: a pair of body units 100 facing each other each having one end branched into a supporting portion 110 and a pressurizing portion 120, in which an insertion groove 130 into which a part of the electric vehicle is inserted is formed between the support member 110 and the pressurizing portion 120; a pressurizing member 200 rotatably installed inside the pressurizing portion 120 to pressurize the battery module assembly by controlling the surface pressure while selectively and partially protruding outward from the pressurizing portion 120; and a control unit 300 provided on one side of the body unit 100 to control a rotating degree of the pressurizing member 200 to control a protruding degree of the pressurizing member 200 outward from the pressurizing portion 120.

The body unit 100 has the one end in which the supporting portion 110 and the pressurizing portion 120 protrude, and the insertion groove 130 into which the battery module assembly 1 and a part of the electric vehicle are inserted is dented between the supporting portion 110 and the pressurizing portion 120.

In addition, the body unit 100 has a flat opposite end installed on a central area of a top surface thereof with a grip member 140 to be gripped when the fixing jig is carried. The grip member 140 is approximately formed in an inverted rectangular ‘U’ shape and has both ends fixed to the top surface of the body unit 100 so as to be gripped by a user when the fixing jig is carried.

It may be effective that the pressurizing portion 120 has a length relatively longer than a length of the supporting portion 110, so that the pressurizing member 200 rotatably installed inside the pressurizing portion 120 has a larger rotation radius.

The pressurizing member 200 refers to a member rotatably installed inside the pressurizing portion 120 and configured to pressurize the battery module assembly by controlling the surface pressure while selectively and partially protruding outward from the pressurizing portion 120.

The pressurizing member 200 has a width is required to have a width at least smaller than an internal width of the pressurizing portion 120 to allow the pressurizing member 200 to be rotatably installed inside the pressurizing portion 120. The pressurizing member 200 may preferably have a length relatively shorter than the length of the pressurizing portion 120 so as not to protrude outward from the pressurizing portion 120.

The pressurizing member 200 is rotatably connected to an inside of the pressurizing portion 120 by a fastening bolt 210, and the pressurizing member 200 is provided to rotate along with rotation of the fastening bolt 210, and accordingly, an end of the pressurizing member 200 rotates by controlling a rotation amount of the fastening bolt 210, so that a pressurized degree of the battery module assembly may be controlled.

In addition, a lower side of the pressurizing member 200 is formed with an inclined surface 220 based on a fastening area fastened by the fastening bolt 210. When the pressurizing member 200 rotates, the area formed with inclined surface 220 protrudes outward from the pressurizing portion 120 to pressurize the battery module assembly 1.

In addition, a length of the area formed with the inclined surface 220 based on the fastening area fastened by the fastening bolt 210 in the pressurizing member 200 is relatively shorter than a length of an area excluding the area formed with the inclined surface 220.

In the pressurizing member 200, the length of the area formed with the inclined surface 220 is relatively shorter than the length of the area excluding the area formed with the inclined surface 220, thereby generating a large pressing force by the lever principle even when the area formed with the inclined surface 220 protrudes slightly outward from the pressurizing portion 120, so that the battery module assembly 1 can be firmly fixed.

Meanwhile, the control unit 300 is provided on one side of the body unit 100 and configured to control a rotating degree of the pressurizing member 200 to control a protruding degree of the pressurizing member 200 outward from the pressurizing portion 120.

The control unit 300 includes: a plurality of cylinders 310 each connected to an area opposite to the area fixed to the pressurizing portion 120 and fastened by the fastening bolt 210 so as to rotate the pressurizing member 200; air hoses 320 connected to one sides of the cylinders 310 to apply an air pressure to the cylinders 310, respectively; and a toggle switch 330 for selectively turning on and off a supply of air supplied through the air hose 320.

The cylinder 310 is connected to the pressure member 200 in the area opposite to the area fastened by the fastening bolt 210 and supplied with high pressure air so as to serve to rotate the pressurizing member 200 based on the area fastened by the fastening bolt 210.

In other words, the rotating degree of the pressurizing member 200 may increase when the amount of air supplied to the cylinder 310 increases, and the rotating degree of the pressurizing member 200 may decrease when the amount of air supplied to the cylinder 310 relatively decreases, so that the surface pressure applied by the pressurizing member 200 may be controlled.

The air hose 320 is connected to one side of the cylinder 310 to serve as a passageway for allowing the air to be supplied toward the cylinder 310 a separate air supply port 321 is provided in a central area between the cylinders 310, and a separate air supply equipment is connected to the air supply port 321, so that the air is supplied toward the cylinders 310.

The toggle switch 330 serves to selectively turn the air supply on and off in order to control the amount of air supplied toward the cylinders 310 through the air supply port 321 from the air supply equipment.

Accordingly, the rotating degree of the pressurizing member 200 may be controlled, as a result, the degree of the pressurizing member 200 pressurizing the battery module assembly 1 may be controlled.

A process of fixing the battery module assembly using the fixing jig configured as described above according to the present invention will be described as follows with reference to FIG. 4.

First, the worker grips the grip member 140 of the fixing jig according to the present invention and moves the body unit 100 to a desired position, inserts one side of the electric vehicle into the insertion groove 130, and arranges the pressurizing portion 120 to come in contact with one side of the battery module assembly 1.

When the toggle switch 330 is tilted to one side in the above state to operate the cylinders 310, the separate air supply equipment supplies high pressure air toward the cylinder 310 through the air hose 320 connected to the cylinder 310, so that the cylinder 310 pull one side of the pressurizing member 200 to allow the pressurizing member 200 to rotate.

When the pressurizing member 200 rotates, the inclined surface 220 formed on the pressurizing member 200 protrudes outward from the pressurizing portion 120, thereby gradually pressurizing the one side of the battery module assembly 1.

When it is determined that a predetermined amount of pressure or higher is applied to the battery module assembly 1 by the pressurizing member 200, the operation of the cylinder 310 is stopped by setting the toggle switch 330 to the initial position to stop the rotation of the pressurizing member 200, thereby pressurizing the battery module assembly 1 so that an appropriate surface pressure is applied, and thus the fixing of the battery module assembly using the fixing jig is completed.

The fixing jig according to one embodiment of the present invention having the above-described configuration is configured such that a battery module assembly is fixed by the jig capable of controlling a surface pressure during fixing the battery module assembly to an electric vehicle, thereby preventing a damage to the product's appearance, so that a noise caused by gaps inside the battery module assembly or an overheating of the battery module assembly can be prevented.

Since the present specification has been described merely with respect to some of the preferred embodiments that may be implemented by the present invention, the scope of the present invention, as commonly known, will not be construed as being limited to the above embodiments, and the technical idea of the present invention described above and the equivalents thereof are all covered in the scope of the present invention.

1. A fixing jig capable of controlling a surface pressure for pressurizing a battery module assembly when fixing the battery module assembly to an electric vehicle, the fixing jig comprising:
a pair of body units (100) facing each other each having one end branched into a supporting portion (110) and a pressurizing portion (120), in which an insertion groove (130) into which a part of the electric vehicle is inserted is formed between the support member (110) and the pressurizing portion (120);
a pressurizing member (200) rotatably installed inside the pressurizing portion (120) to pressurize the battery module assembly by controlling the surface pressure while selectively and partially protruding outward from the pressurizing portion (120); and
a control unit (300) provided on one side of the body unit (100) to control a rotating degree of the pressurizing member (200) to control a protruding degree of the pressurizing member (200) outward from the pressurizing portion (120).

2. The fixing jig of claim 1, wherein the pressurizing portion (120) has a length relatively longer than a length of the supporting portion (110).

3. The fixing jig of claim 1, wherein the pressurizing member (200) is rotatably connected to an inside of the pressurizing portion (120) by a fastening bolt (210), and the control unit (300) includes:
a plurality of cylinders (310) each connected to an area opposite to the area fixed to the pressurizing portion (120) and fastened by the fastening bolt (210) so as to rotate the pressurizing member (200);
air hoses (320) connected to one sides of the cylinders (310) to apply an air pressure to the cylinders (310), respectively; and
a toggle switch (330) for selectively turning on and off a supply of air supplied through the air hose (320).

4. The fixing jig of claim 3, wherein the pressurizing member (200) is formed at a lower side thereof with an inclined surface (220) from a fastening area fastened by the fastening bolt (210), and
when the pressurizing member (200) rotates, the area formed with inclined surface (220) protrudes outward from the pressurizing portion (120) to pressurize the battery module assembly.

5. The fixing jig of claim 4, wherein the area formed with the inclined surface (220) based on the fastening area fastened by the fastening bolt (210) in the pressurizing member (200) has a length relatively shorter than a length of an area excluding the area formed with the inclined surface (220).

6. The fixing jig of claim 1, wherein the body unit (100) is installed on a central area of a top surface thereof with a grip member (140) gripped when the fixing jig is carried.
